(19) United States
(12) Patent Application Publication
(10) Pub. No.: US 2008/0140392 A1
(43) Pub. Date: Jun. 12, 2008

(54) CODEC MODE DECODING METHOD AND APPARATUS FOR ADAPTIVE MULTI-RATE SYSTEM

(75) Inventor: Jae Hyoung KIM, Anyang-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/947,529

(22) Filed: Nov. 29, 2007

(30) Foreign Application Priority Data
Dec. 12, 2006 (KR) 2006-0126145

(51) Int. Cl. G10L 19/00; H04L 27/06; H04B 1/38

(52) U.S. Cl. 704/201; 375/341; 375/222; 704/E19.001

(57) ABSTRACT

A codec mode decoding apparatus and method for an AMR communication system for enhancing decoding speed and optimizing memory utilization. The codec mode decoding method includes receiving data encoded using an adaptive multi-rate scheme; extracting a bit value from an informative region of the data by through a channel decoding on the data; producing correlation values by correlating the bit value and at least two codec modes; selecting one of the codec modes, of which correlation value is a maximum likelihood value, as an adapted codec mode; activating a first codec corresponding to the adapted codec mode; and decoding the data using the first codec.

### PRIORITY

This application claims priority under 35 U.S.C. § 119(a) to an application filed in the Korean Intellectual Property Office on Dec. 12, 2006 and assigned Serial No. 2006-0126145, the contents of which are incorporated herein by reference.

### BACKGROUND OF THE INVENTION

1. Field of the Invention

The present invention relates to an Adaptive Multi-Rate (AMR) communication system and, in particular, to a coder/decoder (codec) mode decoding apparatus and method for an AMR communication system that are capable of enhancing decoding speed and optimizing memory utilization.

2. Description of the Related Art

In order to reduce information rate and increase information reliability, various channel coding schemes are adopted in wireless communication systems. For example, conventional Global System for Mobile communication (GSM) systems provide a fixed rate data service. The GSM standard defines three different codec types: GSM full rate, GSM enhanced full rate, and GSM half rate.

A GSM full rate codec supports one fixed codec mode with 13 kbits/sec, a GSM enhanced full rate codec supports one fixed codec mode with 12.2 kbits/sec, and a GSM half rate codec supports one fixed codec mode with 5.6 kbits/sec. Output bits representing coded speech parameters are provided to a channel coder. The channel coding is performed by adding redundancy bits to ordered bits sequence.

Such a channel coding is performed by a fixed number of input bits. An output bits rate of a channel encoder can be adjusted to 22.8 kbits/sec for the full rate codec and 11.4 kbit/sec for the half rate codec.

Such a conventional GSM codec operates in a fixed split manner between the speech and channel coding rates regardless of a link quality. Since the code rate of the channel encoder is not changed until the communication link is changed, the code rate causes delays in channel coding and decoding processes.

In order to optimize the coding rate, an Adaptive Multi-Rate (AMR) codec has been developed to maintain high speech quality under a wide range of transmission conditions. An AMR codec operates in consideration of difference between the speech and channel coding rates for improving speech quality and is adopted as a standard speech codec.

An AMR codec is a multi mode codec for providing better speech quality and increasing network capacity by selecting an optimal codec type in consideration of traffic environment and link quality. An AMR speech coder includes a multi-rate speech coder, a source controlled rate scheme including a voice activity detector and a comfort noise generation system, and an error concealment mechanism to combat the effects of transmission errors and lost packets. A multi-rate speech coder is a single integrated speech codec with eight source rates from 4.75 kbps to 12.2 kbps, and a low rate background noise encoding mode.

A GSM standard specifies only a speech encoding method but not a decoding method, which is open for vendors. AMR codec mode related standards define characteristics of AMR codec modes.

Under the above conditions, firstly received signal based codec mode decoding and probability based codec mode decoding methods have been proposed. In conventional codec mode decoding methods, a soft output value is obtained by a Viterbi decoding technique. That is, a soft-output decoding is performed using a “First Likelihood Parameter” obtained using a first received signal. Secondly, a “second likelihood parameter” of the received signal using a probability model, such as a Markov Model, and then an optimal “combined likelihood” is selected by calculating the “first likelihood parameter” and “second likelihood parameter.” A codec mode is decoded using an optimal combined likelihood selected in such a manner.

However, the conventional codec mode decoding method, as described above, requires large computation time and thus considerable memory capacity due to the use of the probability model, resulting in waste of time. Since the adoption of the probability model retards the decoding speed, the probability model based conventional decoding method is not efficient for a speech signal decoding technique.

### SUMMARY OF THE INVENTION

The present invention substantially solves the above problems, and provides a codec mode decoding method and apparatus for an adaptive multi-rate system that are capable of improving decoding speed and optimizing memory utilization.

In accordance with an aspect of the present invention, provided is a codec mode decoding method for an adaptive multi-rate communication system. The codec mode decoding method includes receiving data encoded using an adaptive multi-rate scheme; extracting a bit value from an informative region of the data by through a channel decoding on the data; producing correlation values by correlating the bit value and at least two codec modes; selecting one of the codec modes, of which a correlation value is a maximum likelihood value, as an adapted codec mode; activating a first codec corresponding to the adapted codec mode; and decoding the data using the first codec.

In accordance with another aspect of the present invention, provided is a codec mode decoding apparatus for an adaptive multi-rate communication system. The codec mode decoding apparatus includes an antenna for receiving data encoded in one of at least two codec modes; a modem for extracting a codec mode on correlation values produced by correlating a bit value contained in the data for indicating the data and at least two modes; and a controller for providing the codec modes to the modem and controlling the modem to perform correlating the bit value and the codec modes in a sequential order.

### BRIEF DESCRIPTION OF THE DRAWINGS

The above and other objects, features and advantages of the present invention will be more apparent from the following detailed description in conjunction with the accompanying drawings, in which:

FIG. 1 is a schematic diagram of an Adaptive Multi-Rate (AMR) communication system employing a codec mode decoding method and apparatus according to the present invention;

FIG. 2 is a block diagram of the receiving terminal of FIG. 1;

FIG. 3A is a graph of a signal received at a receiving terminal adopting a codec mode decoding method according to the present invention;

FIG. 3B is a graph of the signal of FIG. 3A received at a receiving terminal before adopting a codec mode decoding method according to the present invention;

FIG. 4 is a diagram illustrating codec modes stored in the memory unit of the receiving terminal of FIG. 2 in the form of a table;

FIG. 5 is a flowchart of a codec mode decoding method according to the present invention; and

FIG. 6 is a flowchart of a codec mode decoding method according to the present invention.

### DETAILED DESCRIPTION OF THE PREFERRED EMBODIMENTS

Preferred embodiments of the present invention are described with reference to the accompanying drawings in detail. The same reference numbers are used throughout the drawings to refer to the same or like parts. Descriptions of well-known functions and structures incorporated herein may be omitted to avoid obscuring the subject matter of the present invention.

Note that the same or similar elements in the drawings are designated by the same reference numerals as far as possible although they are shown in different drawings.

In the present invention, a coder/decoder (codec) mode decoding technique is provided for decoding a codec mode in an Adaptive Multi-Rate (AMR) wireless communication system. The codec mode decoding technique enables quickly obtaining a codec mode through a correlative computation, thereby increasing decoding speed and conserving memory space.

In the following examples, a codec mode decoding method and apparatus are described with a mobile terminal equipped with an AMR codec. The mobile terminal can be one of a Personal Digital Assistant (PDA), laptop computer, Smartphone, 3^{rd} generation standard mobile terminal, Code Division Multiple Access (CDMA) terminal, Global System for mobile communication (GSM) terminal, Global Packet Radio Services (GPRS) terminal, Wireless Local Area Network (WLAN) terminal, Wireless Broadband (WiBro) Terminal, High Speed Downlink Packet Access (HSDPA) terminal, or the like.

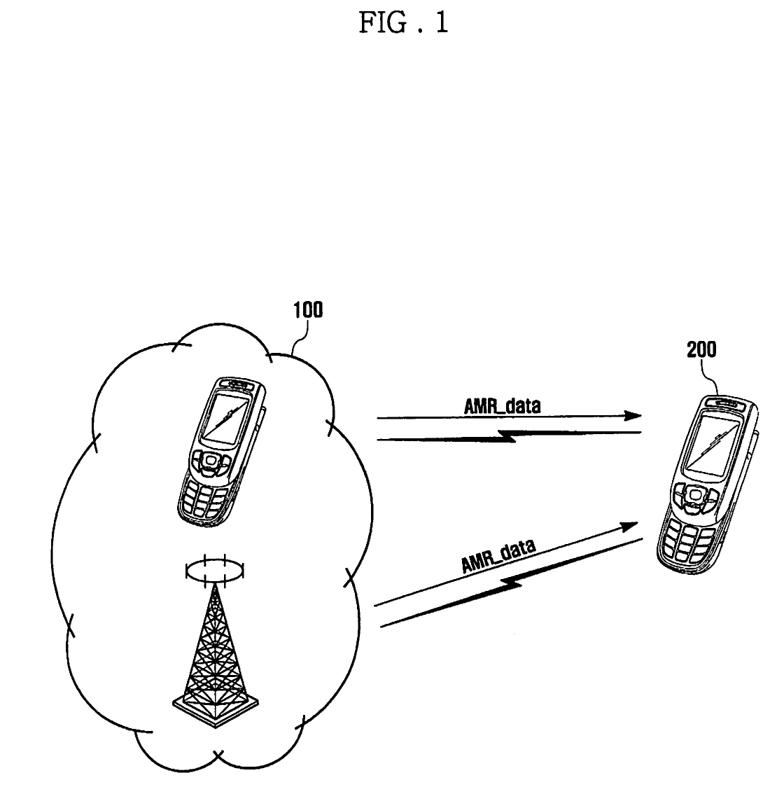

FIG. 1 shows an AMR communication system employing a codec mode decoding method and apparatus according to the present invention. The AMR communication system includes a sending terminal 100 for a sending party which encodes data using an AMR codec and transmits equivalent AMR-coded data (AMR_data) and a receiving terminal 200 which receives the AMR_data and decodes the AMR_data to recover the original data. The sending terminal 100 can be a mobile terminal, a fixed terminal, or a base station.

The sending terminal 100 includes an encoder having an AMR codec, an antenna for transmitting the AMR_data, an audio processing unit, a display unit and keypad unit for supporting composition of a message, and a control unit for controlling the operations of the units. The sending terminal can encode a still picture, motion picture, text message, etc., as well as speech into AMR_data using the AMR codec.

The receiving terminal 200 receives the AMR_data including AMR-coded voice and text message data. The codec mode decoding is described with four AMR codec modes for GSM as an example. However, the present invention is not limited thereto. For example, the codec mode can be determined in accordance with a correlation between a codec mode extracted from a received signal and previously stored codec modes. That is, a number of the codec modes can be changed.

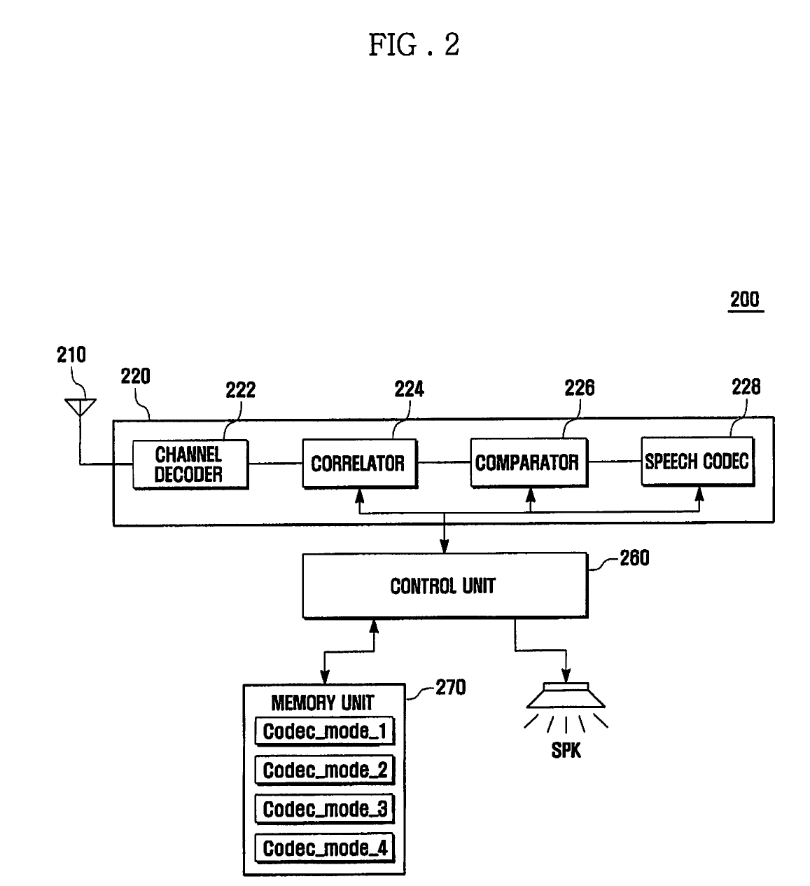

FIG. 2 shows the receiving terminal 200 of FIG. 1. The receiving terminal 200 includes an antenna 210 for receiving a radio signal carrying the AMR_data, a modulator/demodulator (modem) 220 for decoding the AMR_data, an output unit including a speaker (SPK) for outputting decoded data, a control unit 260 for controlling the modem 220 and output unit (SPK) and especially for selecting a codec mode for successfully decoding the AMR_data, and a memory unit 270 for storing a plurality of codec modes (Codec_mode_1, Codec_mode_2, Codec_mode_3, and Codec_mode_4). The output unit can further include a display unit for displaying text messages, pictures, and an interface screen for supporting operation control of the receiving party terminal 200, and a keypad unit for generating key input signals for controlling the receiving party terminal.

The modem 220 includes a channel decoder 222 for performing channel decoding on the received AMR_data, a correlator 224 for calculating a correlation between the decoded data and the previously stored AMR codec modes, a comparator 226 for comparing the correlation values output from the correlator 224 and selecting a codec mode based on the comparison result, and a speech codec 228 for decoding the AMR_data in the codec mode selected by the comparator 226 and outputting the decoded data to the speaker (SPK). The speech codec 228 can be integrated into the control unit 260 or be provided with a data processing unit.

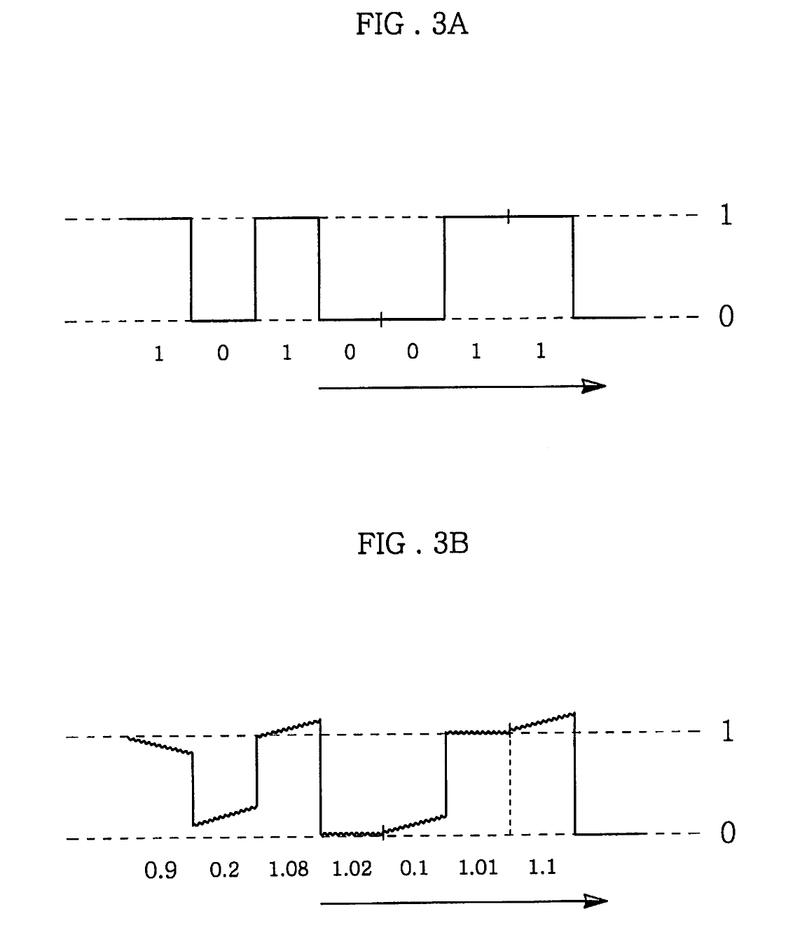

The channel decoder 222 decodes the data received though a communication channel. The channel decoder 222 performs a soft-output channel decoding on the received data to produce an output signal. The output signal is obtained by discarding digits following a specific place to a right side of the decimal point. When a length of bits are transmitted, an original value of an individual bit, i.e. 0 or 1, is decided. For example, when a codeword “1100101”, shown in FIG. 3A, is transmitted by sending terminal, a received signal, shown in FIG. 3B, may be distorted while passing through a wireless channel due to a characteristic of the receiving terminal 200 of FIG. 2. For soft output channel decoding, the distortion level is measured by a right digit of the decimal point in unit of bit, for example, 1.1, 1.01, 0.1, 0.02, 1.08, 0.2, and 0.9. In this example, the channel decoder 222 performs decoding by estimating probabilities of individual bits of the codeword, i.e. the AMR_data. For this purpose, the channel decoder 222 can be implemented with a Viterbi coder/decoder or a turbo coder/decoder.

The correlator 224 produces correlation values by correlating soft output values of the channel decoder 222 and the codec modes (Codec_mode_1, Codec_mode_2, Codec_mode_3, and Codec_mode_4).

By correlating the codec modes (Codec_mode_1, Codec_mode_2, Codec_mode_3, and Codec_mode_4) stored in the memory unit 270 and the soft output value of each bit, a maximum likelihood value among the correlation values is selected. This means that a higher likelihood value is likely to have higher energy.

When the sending terminal 100 transmits the AMR_data of which header indicates one of the codec modes, the channel decoder 222 of the receiving party terminal 200 produces a soft output value identical with one of soft channel decoding values of the codec modes (Codec_mode_1, Codec_mode_2, Codec_mode_3, and Codec_mode_4). Accordingly, the receiving terminal 200 checks the header of the AMR_data and then decodes the codec mode region inserted by the sending terminal 100 and outputs a codec mode, inserted by the sending terminal 100, in the form of a soft output value. Next, the correlator 224 of the receiving terminal 200 produces correlation values by correlation the soft output value and each of the codec modes (Codec_mode_1, Codec_mode_2, Codec_mode_3, and Codec_mode_4) and checks whether the soft output value is a correct value. The correlator 224 can be an integral correlator, a differential correlator, a time integral correlator, a convolution correlator, multiplication correlator, and their equivalents that can produce a correlation value from two variables.

The comparator 226 compares the correlation values produced by the correlator 224 and extracts a maximum likelihood value among the correlation values, i.e. the correlation value having the highest energy. When the correlator 224 is a convolution correlator, the correlator 224 convolutes each of the codec modes (Codec_mode_1, Codec_mode_2, Codec_mode_3, and Codec_mode_4) with the soft output value, and the comparator 226 compares the soft output value and the correlation value for estimating a correlation likelihood. In order for the comparator 226 to compare the soft output values and the codec modes (Codec_mode_1, Codec_mode_2, Codec_mode_3, and Codec_mode_4), a temporary memory or buffer can be provided. The correlation values output by correlating the soft output value and the codec modes (Codec_mode_1, Codec_mode_2, Codec_mode_3, and Codec_mode_4) are temporarily stored in the temporary memory and buffer for estimating a maximum likelihood value among the correlation values. When a codec mode producing a maximum likelihood value is estimated, the comparator 226 informs at least one of the voice codec 228 and the control unit 260 of the codec mode producing the maximum likelihood value. If the speech codec 228 informs that the codec mode selected by the comparator 226 is incorrect, the comparator 226 selects and informs a codec mode producing the next order higher likelihood value.

The speech codec 228 activates the codec mode selected by the comparator 226 and performs decoding on the data including speech data and text message data so the speech and the text message are output through the speaker and display unit, respectively. In this example the AMR_data is mainly explained with speech and text. However, the present invention is not limited thereto. For example, the AMR_data can carry still and motion picture data. In this case, the speech codec 228 can be replaced with a video codec. The speech codec 228 performs decoding on the AMR_data in accordance with the codec mode selected by the comparator 226. The speech codec 228 can check whether the decoding is correctly performed. When the AMR_data is erroneously decoded with an error, the comparator 226 recognizes an incorrect codec mode selection and informs the control unit 260 of the incorrect codec mode selection. When another codec mode is informed by the comparator 226, the speech codec 228 performs decoding on the AMR_data with the proper codec mode. The codec mode selected by the comparator 226 can be informed through the control unit 260.

The speaker (SPK) outputs the decoded data in the form of an audible sound wave in accordance with a voltage corresponding to the decoded data.

The control unit 260 controls the correlator 224 to correlate the soft output values output from the channel decoder 222 and the codec modes (Codec_mode_1, Codec_mode_2, Codec_mode_3, and Codec_mode_4) stored in the memory unit 270. The codec modes are provided to the correlator 224 in a sequential order. The control unit 260 controls correlation values output from the correlator 224 so they are sequentially input to the comparator 226 and the comparator 226 selects a codec mode producing a maximum likelihood or having a highest energy and informs the speech codec 228 of the selected codec. If an error occurs while the speech codec decodes the AMR_data in accordance with the codec mode selected by the comparator 226, the control 260 controls the comparator 226 to select another codec mode. Thus, the comparator 226 selects a codec mode producing a next order higher likelihood and informs the control unit 260 and the speech codec 228 of the newly selected codec mode.

The memory unit 270 stores the codec modes (Codec_mode_1, Codec_mode_2, Codec_mode_3, and Codec_mode_4) and sequentially provides the codec modes (Codec_mode_1, Codec_mode_2, Codec_mode_3, and Codec_mode_4) to the modem 220 under the control of the control unit 260.

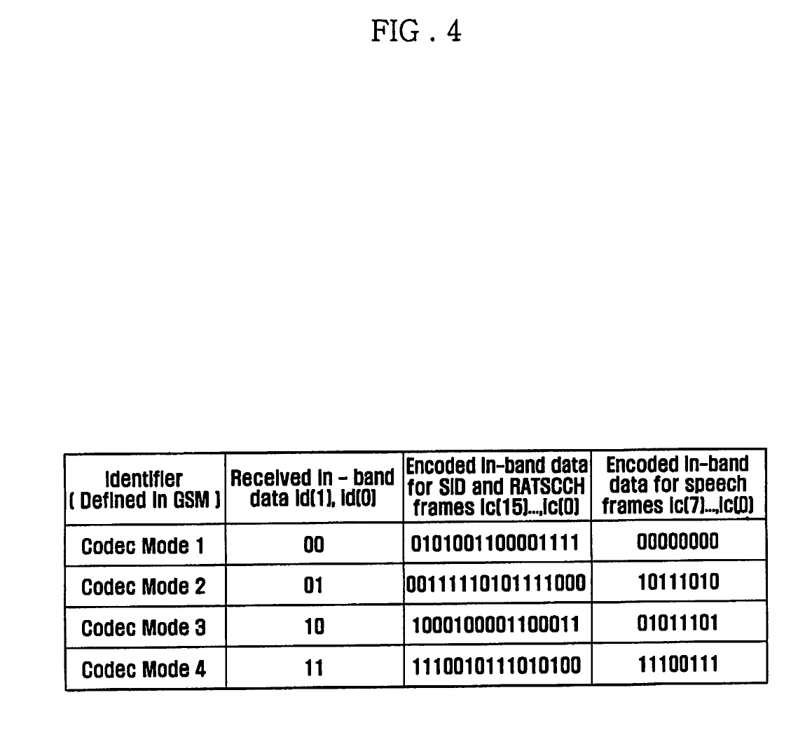

FIG. 4 shows codec modes stored in the memory unit 270 of the receiving terminal 200 of FIG. 2 in the form of a table. The memory unit 270 stores the four codec modes (Codec_mode_1, Codec_mode_2, Codec_mode_3, and Codec_mode_4) in the form of a table. Each of the four codec modes defined in GSM has a 2-bit in-band index and a bit stream corresponding to the in-band index. The bit stream are information inserted in a header of the AMR_data as one of “Encoded in-band data for SID and RATSCCH Frame ic (15), . . . , ic(0)” or “Encoded in-band data for speech frames ic(7), . . . , ic(0).”

That is, each of the AMR codec modes adopted to the GSM has an identifier, i.e. one of Codec_mode_1, Codec_mode_2, Codec_mode_3, and Codec_mode_4, and an index value “00” for Codec_mode_μl “01” for Codec_mode_2, “10” for Codec_mode_3, and “11” for Codec_mode_4. The Codec_mode_1 has a frame value “0101001100001111” or “00000000”, the Codec_mode_2 has a frame value “00111110101111000” or “10111010”, the Codec_mode_3 has a frame value “1000100001100011” or “01011101”, and the Codec_mode_4 has a frame value “1110010111010100” or “11100111.” The AMR codec adopted to the sending terminal 100 and the receiving terminal 200 is provided with four codec modes. However, the present invention is not limited thereto. For example, the codec mode decoding method of the present invention can be adopted to other wireless communication system, such as a Code Division Multiple Access (CDMA) system, a Universal Mobile Telecommunication System (UMTS), etc., and the number of the codec modes can be changed in accordance with the communication system and channel environment.

A codec mode decoding operation in the above structured mobile terminal is described hereinafter. The following AMR codec mode decoding method is described with four AMR codec modes adopted in the GSM. It is assumed that the sending terminal 100 AMR-coded data (AMR_data) to the receiving terminal 200.

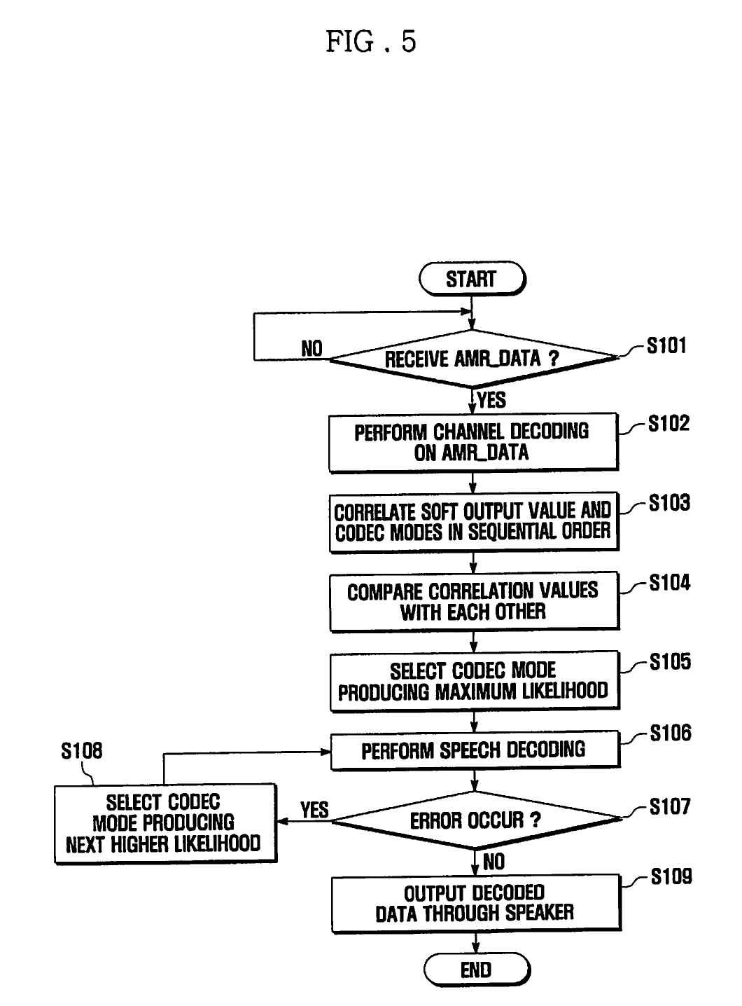

FIG. 5 shows a codec mode decoding method according to the present invention. When a signal is received in an AMR codec mode decoding method, the receiving terminal 200 determines whether the signal is AMR_data encoded by an AMR speech codec in step S101. If the signal is AMR_data, the receiving terminal 200 inputs the AMR_data to the channel decoder 222 so the channel decoder 222 performs channel-decoding on the AMR_data in step S102. The channel decoder 222 decodes a header of the AMR_data and estimates a bit value of the AMR codec mode region. The channel decoder 222 performs a soft output channel decoding to produce a soft output value having a number of places following the decimal point.

The receiving terminal 200 then performs correlation between the soft output value and the codec modes (Codec_mode_1, Codec_mode_2, Codec_mode_3, and Codec_mode_4) stored in the memory unit 270, in a sequential order in step S103. At step S103, the correlator 224 produces correlation values by correlating the codec modes (Codec_mode_1, Codec_mode_2, Codec_mode_3, and Codec_mode_4) and the soft output values output from the channel decoder 222. The correlator 224 can be any of an integral correlator, a differential correlator, a time integral correlator, a convolution correlator, multiplication correlator, and their equivalents, that can produce a correlation value from two variables.

The receiving terminal 200 then compares the correlation values with each other in step S104. At step S104, the comparator 226 of the receiving terminal 200 compares the correlation values produced by the correlator 224 with each other and extracts a codec mode which results in maximum likelihood to the soft output value. That is, the comparator 224 selects a codec mode having a maximum likelihood value among the codec modes (Codec_mode_1, Codec_mode_2, Codec_mode_3, and Codec_mode_4). The correlation value can be expressed as a likelihood or energy value. The correlation values can be stored in a temporary memory or a buffer.

The receiving terminal 200 selects the codec mode producing the maximum likelihood value in step S105 and performs speech decoding based on the selected codec mode in step S106. At step S106, the comparator 226 of the receiving terminal 200 selects the codec mode producing the maximum likelihood value and informs the speech codec 228 of the selected codec mode. Accordingly, the speech codec 228 activates the codec corresponding to the selected codec mode and performs decoding on the data contained in the AMR_data using the activated codec.

The receiving mobile terminal 200 determines whether an error occurs while the speech codec 228 performs decoding with the activated codec in step S107. If an error is detected, the receiving mobile terminal 200 selects another codec mode produced a next higher likelihood value in step S108 and then restarts the decoding operation in step S106. At step S107, when AMR_data is erroneously decoded in the selected codec mode, i.e. an error occurs while decoding the AMR_data, the speech codec 228 informs the control unit 260 that the selected codec mode is an incorrect codec mode. Consequently, the control unit 260 informs the comparator 226 of the incorrect codec mode and the comparator 226 selects another codec mode producing a next higher likelihood value and informs the speech codec 228 of the newly selected codec mode.

When no error is detected at step S107, the receiving terminal 200 outputs the decoded data through the speaker (SPK) as an audible sound wave in step S109.

The codec mode decoding method described above selects a codec mode based on correlations between a received signal and codec modes, and the codec mode for decoding the received signal can be decided in a simple and fast manner, resulting in decoding speed and memory utilization improvement.

This codec mode decoding method has been described with a speech signal. However, the present invention is not limited to the speech signal. For example, AMR_data can carry text, a still picture, a moving picture, etc.

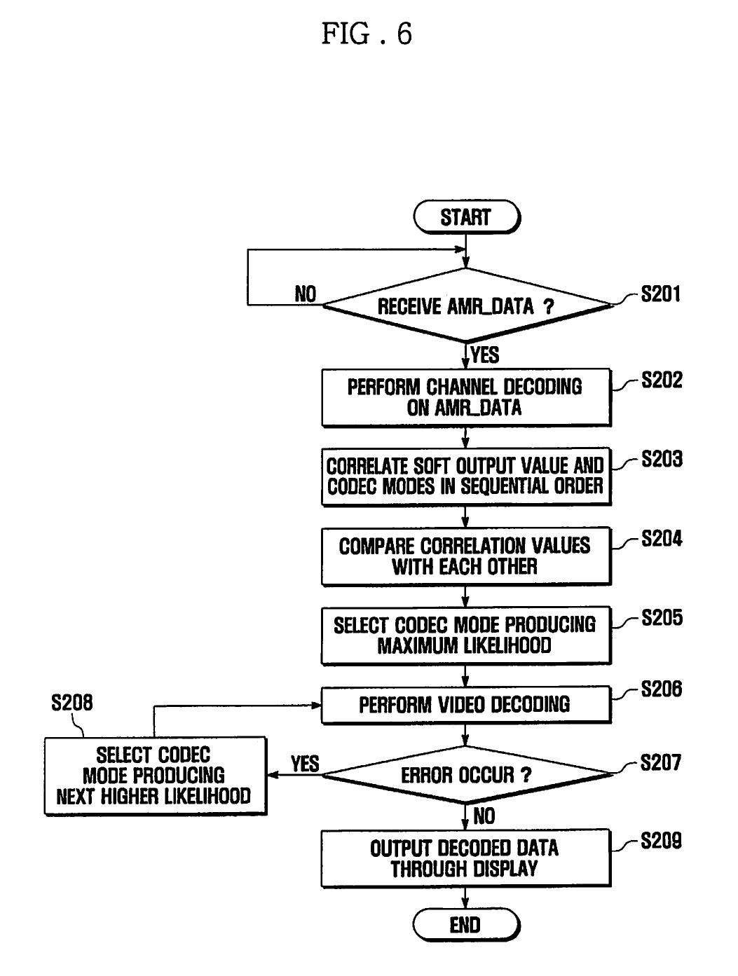

FIG. 6 shows another a codec mode decoding method according to the present invention. In this AMR codec mode decoding method, the receiving terminal 200 determines whether the signal is an AMR_data encoded by an AMR speech codec in step S201 when a signal is received. In this example, the AMR_data carries a text, a still picture, a motion picture, etc., and the speech codec is replaced by a video codec.

When the signal is AMR_data, the receiving terminal 200 inputs the AMR_data to the channel decoder 222 so the channel decoder 222 performs channel-decoding on the AMR_data in step S202. At step S202, the channel decoder 222 decodes a header of the AMR_data and estimates a bit value of the AMR codec mode region. The channel decoder 222 performs a soft output channel decoding to produce a soft output value having a number of places following the decimal point.

The receiving terminal 200 then performs correlation between the soft output value and the codec modes (Codec_mode_1, Codec_mode_2, Codec_mode_3, and Codec_mode_4) stored in the memory unit 270 in a sequential order in step S203.

This codec mode decoding method has been described with a speech codec. However, the present invention is not limited to the speech codec. For example, the AMR codec can be implemented with a video codec for decoding text, a still picture, a motion picture, etc.

Next, the receiving party terminal 200 compares the correlation values with each other in step S204. At step S204, the comparator 226 of the receiving terminal 200 compares the correlation values produced by the correlator 224 with each other and extracts a codec mode with results in maximum likelihood to the soft output value. The correlation values are stored in a temporary memory or a buffer.

The receiving terminal 200 then selects the codec mode producing the maximum likelihood value in step S205 and performs video decoding based on the selected codec mode in step S206.

While performing video decoding, the receiving terminal 200 determines whether an error occurs in step S207. When an error is detected, the receiving terminal 200 selects another codec mode produced a next higher likelihood value in step S208 and then restarts the decoding operation in step S206.

When no error is detected at step S207, the receiving terminal 200 outputs the decoded data, for example a picture and text, on the display unit in step S209.

As described above, a codec mode decoding method and apparatus for an adaptive multi-rate system according to the present invention selects a codec mode for decoding the AMR-codec data, such as speech, text, still pictures, motion pictures, etc., using correlations between a soft output value and codec modes, resulting in decoding speed and memory utilization improvement.

Although preferred embodiments of the present invention are described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A coder/decoder (codec) mode decoding method for an adaptive multi-rate communication system, the method comprising:
receiving data encoded using an adaptive multi-rate scheme;
extracting a bit value from an informative region of the data by through a channel decoding on the data;
producing correlation values by correlating the bit value and at least two codec modes;
selecting one of the codec modes, of which correlation value is a maximum likelihood value, as an adapted codec mode;
activating a first codec corresponding to the adapted codec mode; and
decoding the data using the first codec.

2. The codec mode decoding method of claim 1, further comprising:
determining whether an error occurs while decoding the data using the first codec;
selecting one of the codec modes, of which a correlation value has a next higher likelihood, as a next adapted codec mode when the error occurs;
activating a second codec corresponding to the next adapted codec mode; and
decoding the data using the second codec.

3. The codec mode decoding method of claim 1, further comprising storing the correlation values temporarily prior to selecting the adapted codec mode.

4. The codec mode decoding method of claim 1, wherein the correlation values are produced through at least one of an integral correlation, differential correlation, convolution correlation, and time integral correlation.

5. The codec mode decoding method of claim 1, wherein the bit value has a number of digits following a decimal point.

6. The codec mode decoding method of claim 1, wherein the data carries at least one of a speech, a text, a still picture, and a motion picture.

7. The codec mode decoding method of claim 1, wherein each codec mode comprises an identifier for identifying the codec mode, a received in-band data identifier (ID), in-band data encoded for channel frames, and in-band data encoded for speech frames.

8. The codec mode decoding method of claim 7, wherein producing correlation values comprises comparing one of the bit value and in-band data encoded for channel frames and in-band data encoded for speech frames.

9. A coder/decoder (codec) mode decoding apparatus for an adaptive multi-rate communication system, the apparatus comprising:
an antenna for receiving data encoded in one of at least two codec modes;
a modulator/demodulator (modem) for extracting the codec mode on correlation values produced by correlating a bit value contained in the data for indicating the data and at least two codec modes; and
a controller for providing the codec modes to the modem and controlling the modem to perform correlating the bit value and the codec modes in a sequential order.

10. The codec mode decoding apparatus of claim 9, wherein the modem comprises:
a channel decoder for decoding a channel carrying the data;
a correlator for producing the correlation values by correlating the bit value and the codec modes;
a comparator for comparing the correlation values with each other and selecting one of the codec modes as a first codec mode; and
a speech codec for decoding the data in the first codec mode.

11. The codec mode decoding apparatus of claim 10, wherein the first codec mode produces a maximum likelihood when correlated with the bit value.

12. The codec mode decoding apparatus of claim 11, wherein the speech codec determines whether an error occurs while decoding the data using the first codec and reports an error to the comparator when an error occurs.

13. The codec mode decoding apparatus of claim 12, wherein the comparator selects a second codec mode which produces a next higher likelihood when correlated with the bit value when an error is reported from the speech codec.

14. The codec mode decoding apparatus of claim 9, wherein the data carries at least one of a speech, a text, a still picture, and a motion picture.

15. The codec mode decoding apparatus of claim 9, further comprising a display for displaying at least one of a text, a still picture, and a mobile picture.

16. The codec mode decoding apparatus of claim 9, wherein the bit value has a number of digits following a decimal point.

17. The codec mode decoding apparatus of claim 9, wherein each codec mode comprises an identifier for identifying the codec mode, a received in-band data identifier (ID), in-band data encoded for channel frames, and in-band data encoded for speech frames.

18. The codec mode decoding apparatus of claim 17, wherein the correlator compares one of the bit value and the in-band data encoded for channel frames and the in-band data encoded for speech frames.
